(19) United States
(12) Patent Application Publication
(10) Pub. No.: US 2017/0209319 A1
(43) Pub. Date: Jul. 27, 2017

(54) ELEVATING WALKER CHAIR

(71) Applicant: Exokinetics, Inc., Pottstown, PA (US)

(72) Inventors: John Christopher Fawcett, Whitehead (GB); Garrett W. Brown, Philadelphia, PA (US)

(73) Assignee: Exokinetics, Inc., Pottstown, PA (US)

(21) Appl. No.: 15/326,113

(22) PCT Filed: Jul. 10, 2015
(86) PCT No.: PCT/US2015/040036

§ 371 Date: Jan. 13, 2017

Related U.S. Application Data
(60) Provisional application No. 62/024,006, filed on Jul. 14, 2014.

(51) Int. Cl. A61G 5/14; A61G 5/12; A61G 7/10; A61G 5/04; A61H 3/04

(52) U.S. Cl. CPC A61G 5/14; A61G 5/048; A61H 3/04; A61G 7/1017; A61G 7/1051; A61G 7/1059; A61G 5/125; A61H 2003/043; A61H 2201/0192; A61H 2201/1633; A61H 2201/1635

(57) ABSTRACT

An elevating walker chair that allows both riding and walking. The chair elevates by a parallelogram power unit. The seat transforms between a saddle and seat upon changes in saddle/seat elevation. Also a lifting parallelogram power unit structure. Disclosed is an elevating walker chair for people with limited mobility resulting from compromised musculature, coordination or balance, or for able bodied individuals that must perform tasks for which assistance is desired.

### CROSS-REFERENCE TO RELATED APPLICATION

This International Patent Application claims priority to U.S. Provisional Patent Application Ser. No. 62/024,006, filed Jul. 14, 2014, entitled: ELEVATING WALKER CHAIR, the entirety of which is incorporated herein by reference as it set forth herein in it's entirety.

### BACKGROUND OF THE INVENTION

Conventional devices to assist individuals having mobility difficulties fall into two broad categories—walkers and wheelchairs—plus several intermediate combinations that may additionally help occupants rise up and ambulate.

Walker devices, such as the standard “Zimmer Frame,” add support and stability but involve the user's hands and arms to an extent that precludes carrying or manipulating anything while moving. Four-wheeled walkers may also include seats, but they can't be employed unless the user stops and turns around.

Walkers are slow and isolating, and inherently dangerous when set aside in order sit down.

Most wheelchair (and powered wheelchair) users remain interminably seated, at the expense of muscular, circulatory, and cardiac well-being.

‘Elevating’ wheelchairs employ large motors to raise strapped-in occupants to a standing position and some can power them from place to place while upright, but without reinforcing ambulatory abilities or requiring any muscular contribution

Another intermediary category of assistive devices includes ‘stand-up’ walkers, which partly lift occupants up and down and encourage them to walk.

Unfortunately, existing stand-up walkers inhibit user interactions with the world—either by having large structures ahead and rear entry, or with clumsily uncomfortable folding seats, procedures and restraints. And the users must still lift a significant percentage of body weight with legs and arms in order to rise from a seated to a standing position.

What is missing is a means for individuals with ambulatory limitations to sit and stand at will, to walk with a natural gait, and to safely and easily interact with their environment—to cook, clean, do the wash, get dressed and transport themselves—all at the altitude desired, and always with at least a small component of their own energy and former athleticism.

### SUMMARY OF THE INVENTION

Disclosed is an elevating walker chair for people with limited mobility resulting from compromised musculature, coordination or balance, or for able bodied individuals that must perform tasks for which assistance is desired. The elevating walker chair provides a novel hybrid of riding and walking that encourages ones normal gait yet prevents falling. An illustrative embodiment of the invention allows a user to stroll, stride and coast and relatively easily sit down and rise up—all in a functionally equipoised and weightless condition—without having to exit the device, and with hands free as needed for other purposes.

### DESCRIPTION OF THE DRAWINGS

The following figures depict illustrative embodiments of the invention:

FIG. 1 depicts a full perspective view of an illustrative embodiment of the elevating striding chair of the invention.

FIGS. 2a-b depict side elevations of the chair 1 showing a saddle/seat unfolded to form a chair in the lowered position and with wings folded to form a saddle in the in the raised position.

FIGS. 3a-b depict perspective views of the lifting chassis 3 of the invention including parallelogram struts, plus a close, transparent rendering of the resilient lifting cassette.

FIGS. 4a-b depict side elevations of two alternate positions of a cassette axle along a slot, generally associated with differences in payload lifting performance.

FIGS. 5a-b depict side elevations of various selected mounting angles for lifting the extension frame to yield potentially identical lifting performance if lifting-frame angle to cassette centerline angle is consistent.

FIGS. 6a-c depict deployment positions for left/right armrest assemblies that lock and unlock the seat height and rear wheels, as the user transitions from seat mode, upward to saddle mode and ambulation.

FIGS. 7a-d depict progressive engagement by a user with the actuating armrest control functions of the invention, as he boards and effects a downward transition to seated height.

FIG. 8 depicts the armrests being employed to stabilize and partly support an ambulating user, riding on folding saddle/seat and displaying a posture for walking, striding and/or coasting.

FIG. 9 shows a perspective view of a right-hand actuating of the armrest assembly with a top cover plate 12a to illustrate armrest positions yielded by excursions of fore/aft uneven-parallelogram struts.

FIG. 10 depicts a folding seat/saddle assembly with a wing and seat mounting block showing how a seat mounting post facilitates limited dynamic side-to-side swiveling of the seat/saddle in order to provide a path for rearwardly striding legs.

FIGS. 11a,b depict a saddle/seat and show how a seat wing is swung upward by a wing deployment strut into seat mode as the saddle descends.

FIGS. 12a,b depicts an elevating lifting chair that lifts and lowers a seat carriage assembly between walking and seat heights by means of a left/right resilient member and linear bearing assemblies.

FIG. 12c is a perspective view of a linear bearing assembly running between a linear bearing track pair.

FIGS. 13a,b depict both low seat and elevated saddle deployments of an elevating walker chair suitable for industrial use that provides support for the combined weight of a workman or other user, a resiliently powered payload support arm and a gimbaled industrial tool payload.

FIG. 14 depicts a maximum height adjusting screw and striker plate function to set maximum saddle height as appropriate for rider's inseam measurement.

FIGS. 15a,b,c depict a seat for an elevating lifting chair than transforms from a seat shape to a saddle shape.

FIG. 16 depicts an articulated arm attached to a gimballed tool holder.

FIGS. 17a-d depict an illustrative arm rest with cam or crankshaft axles that actuate braking and lift-locking functions through sequential deployment positions.

FIGS. 18a,b depict the underside of a seat for an elevating walker chair.

### DETAILED DESCRIPTION OF THE INVENTION

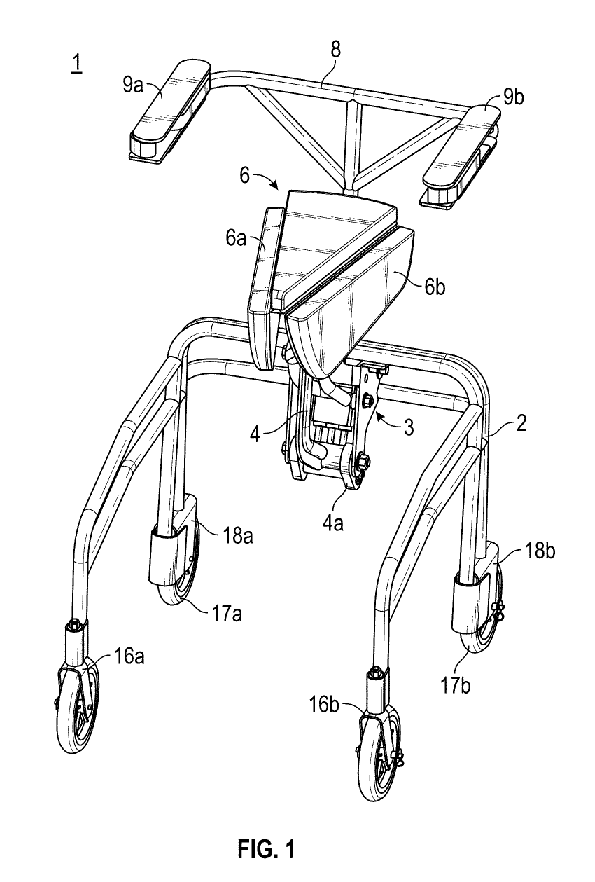

FIG. 1 depicts a perspective view of an elevating walker chair 1 according to an illustrative embodiment of the invention, seen in its elevated ‘walking’ position, including wheeled frame 2 attached to lifting chassis 3, components of which resiliently pivot lifting extension frame 4a downward and attached lifting strut 4 upward, with a force calibrated to permit folding saddle/seat 6 to equipoise its occupant by counterbalancing the occupant's weight to provide an essentially “weightless” condition, as the frame rises toward the upward limit of its parallelogram-supported excursion.

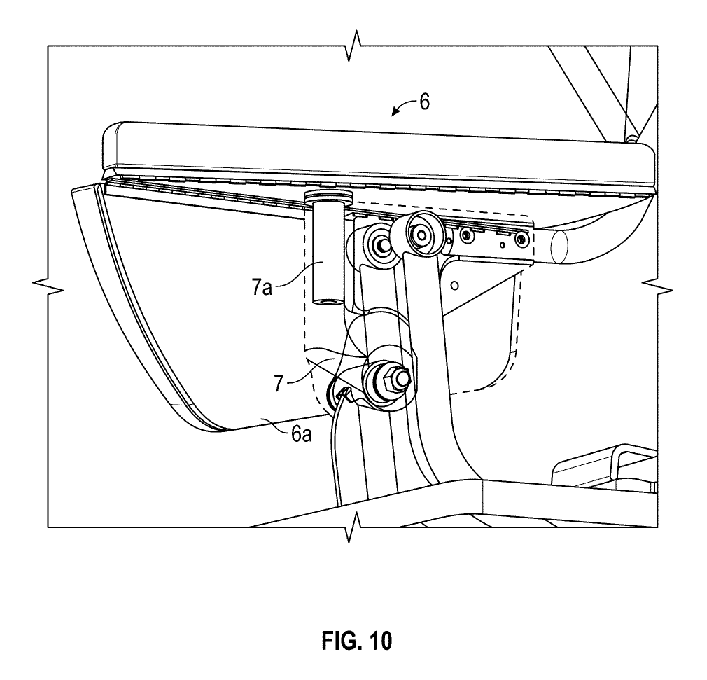

Armrest/seat back frame 8 is attached to seat mounting block 7 (shown in FIG. 10), and supports armrest assemblies 9a, 9b. Left and right folding seat wings 6a, 6b are shown folded downward in the ‘saddle’ position, which is suitable for elevated seating. Armrests 6a,b are shown in a retracted position, but can be optionally forward deployed, which can aid in supporting the torso in a position for walking. Sufficient clearance of the seat with respect to the ground frame 2, including to the sides of the seat and below is provided to permit a walker's legs and feet to stride to the rear or to engage the ground sideways if desired.

Because embodiments of the invention permit ambulation without frontal obstructions as found in traditional walkers, a user will retain forward access at various heights, including a standing height, to sinks, stoves, closets, etc. and will be able to maneuver in between.

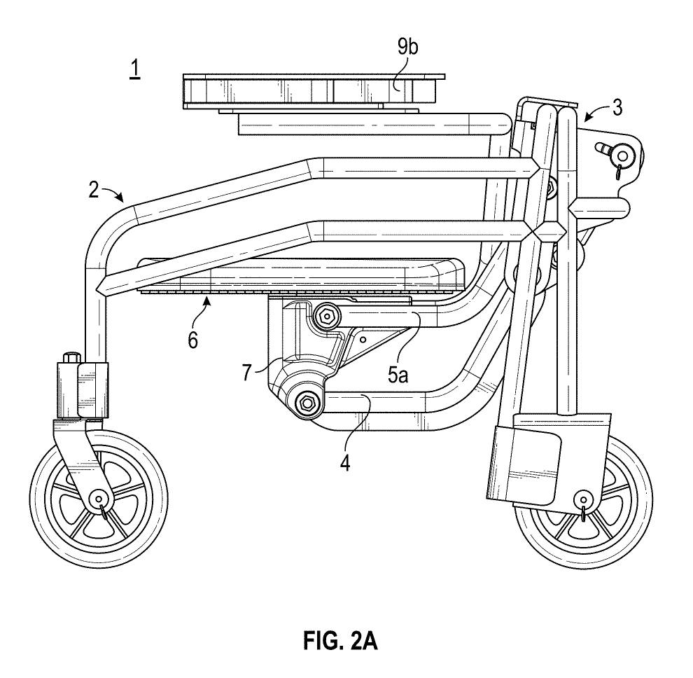

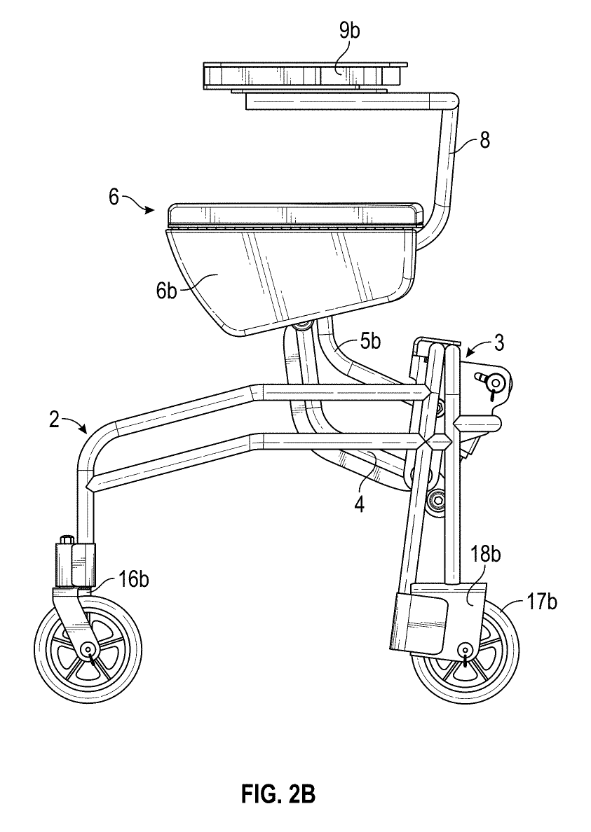

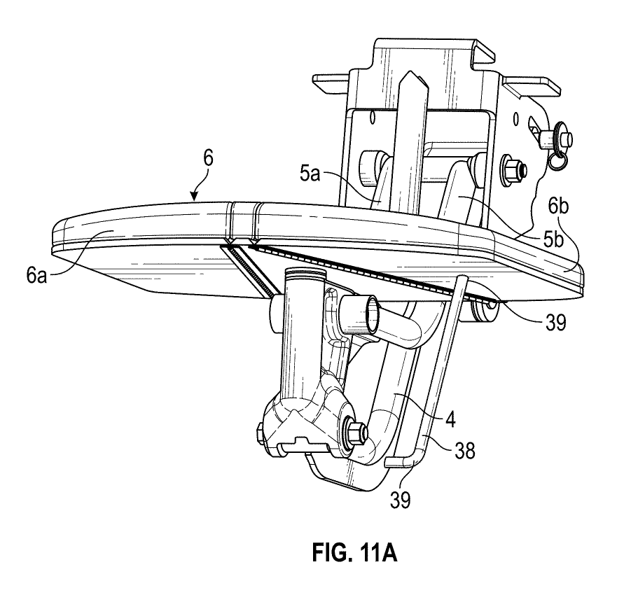

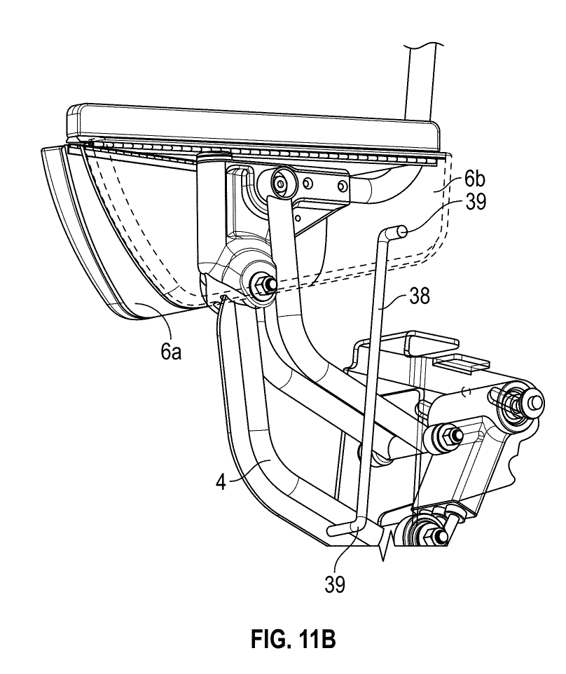

FIGS. 2a,b depict side elevations of elevating walking chair 1. FIG. 2a shows saddle/seat 6 unfolded to form a chair, and at its lowest, chair-height position. The chair height is modified by a parallelogram apparatus formed by seat mounting block 7, lower parallelogram lifting strut 4, upper parallelogram struts 5a,b and lifting chassis 3. In this position, elevating walking chair 1 functions as a conventional chair, which can optionally include an upholstered seat back and padding for armrests 9a,b. Seat frame 2 can be formed of any appropriately strong material including carbon fiber, curved aluminum box beam, etc. Note that lifting strut 4 and parallelogram struts 5a,b are bent in the illustrative embodiments of the invention depicted in the drawings. The bends allow the seat to occupy space that would not otherwise be available, thereby increasing the seat's excursion distance as compared to an embodiment wherein the struts are straight. FIG. 11a illustrates the position of seat 6 within curved parallelogram struts 5a,b. The bends allow the back edge of the seat to clear the struts when the seat is lowered. Curved lifting strut 4 can also enlarge the available space for seat 6. Although lifting strut 4 and parallelogram struts 5a,b are curved they are configured to perform in a manner analogous to configurations with straight parallelogram sides.

FIG. 2b shows seat 6 swung up to a selected elevated position for ambulation. Seat wings 6a,b are folded down to form tapered saddle 6. Seat frame 8, which is attach to seat mounting block 7, supports armrest assemblies 9a,b. Rear wheels 17a,b are preferably of fixed orientation, i.e. non-swivalable, and are attached to motor mounting plates 18a,b, which can be adapted to receive conventional small, self-contained motor and battery sets (not shown), to optionally supplement foot and leg power as needed, and assist steering maneuvers by applying incremental forward and reverse torques to the rear wheels. A preferably wireless joystick (not shown) can be attached to the top surface of armrest 9a or 9b, to add slight forward, rearward or turning motive power as needed, to just the degree required to supplement an individual's abilities.

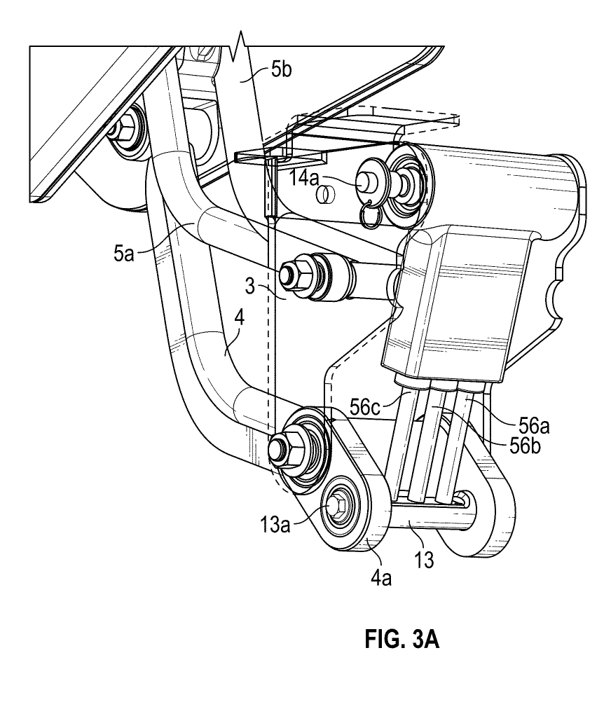

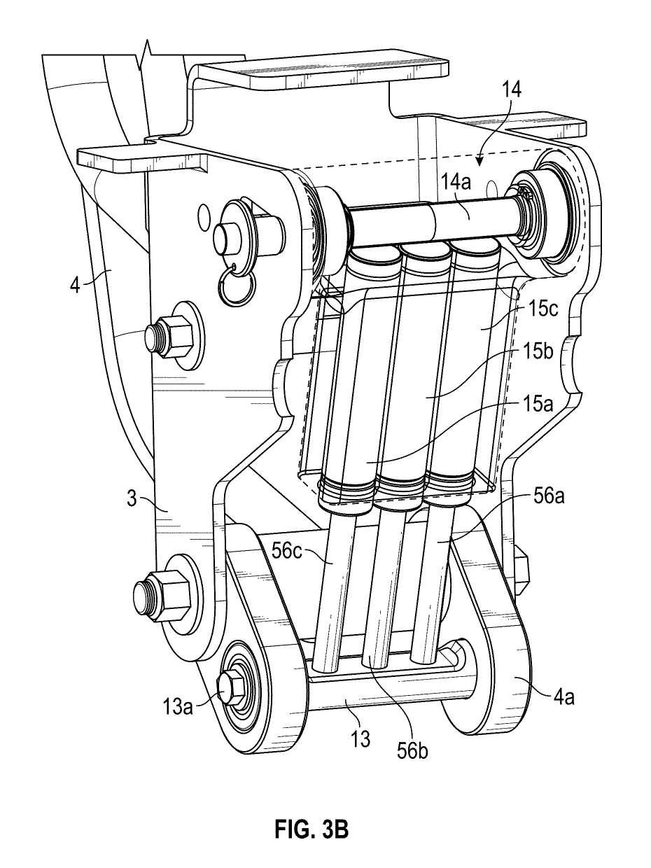

FIG. 3a depicts a perspective view of lifting chassis 3 that includes a lifting cassette 14 that houses resilient power units 15a,b,c (shown in FIG. 3b) whose extendable shafts 56a,b,c are seen engaging receiver bar 13. Receiver bar 13 pivots on axle 13a within the end of lifting extension frame 4a, which is connected to and pivots lower parallelogram lifting strut 4 upward to elevate saddle/seat 6 and its human payload.

FIG. 3b includes a transparent rendering of resilient lifting cassette 14, showing its internally-mounted resilient power units 15a,b,c—such as small, powerful gas springs, for example. The resilient power units can be selected in a combination that will closely equipoise the weight of the seat occupant. Cassette 14 pivots within chassis 3 around axle 14a so that its internal resilient units (such as gas springs) can remain extendably in contact with receiver 13. Since the illustrated gas springs 15a,b,c provide a powerful compression force, they bias extension frame 4a strongly downward, in the manner of the ‘heavy kid’ on the short end of a seesaw, who can counterbalance the ‘light kid’ on his much longer end. In fact, since the effective pivot-to-pivot length of strut 4 in this embodiment is about 6.9 times the pivot length of extension 4a, then the sum of the forces exerted by a given set of gas springs 15a,b,c can be divided by that ratio to indicate the approximate weight of a person they would support. For a closer approximation, the weight of seat 6 must be included, minus approximately half the separate weight of the persons legs—but in practice it is found that a person's weight plus about 10 lbs provides a good indication of the net gas spring lifting power that will successfully ‘float’ the person in an equipoised condition that lets them rise up and sit down as if in “zero gravity.”

The chart below illustrates the net lifting value of some available gas spring type resilient power units, as may be illustratively employed in embodiments of the invention. It can be seen that the most powerful gas spring in this list will actually lift a net payload of nearly 100 lbs (at the forward payload end of the lifting parallelogram) as each cassette is pressured to provide up to 691 lbs of extending force.

Even though outer gas springs (15a and 15c) should be selected to be identical (to avoid drastically off-center loads on receiver bar 13 and extension frame 4a), it is clear that combinations of available net lifting values can easily be specified to approximately ‘float’ nearly anyone weighing from 80 lbs to 300 lbs.

Combinations of resilient power component can include for example, a single central spring, two identical outer springs, or a combination of one inner and two identical outer springs. Other numbers of individual power component can be used; however, it is preferable to avoid off-centered forces. In an illustrative embodiment of the invention, combinations are selected to equal the rider's weight plus about 10 lbs:

The chart below shows parameters of illustrative gas springs. The gross lift is that which the spring inherently possesses. The net lift is the gross lift divided by 6.9, which is an illustrative ratio between the length of lifting strut 4 and extension frame 4a. In this illustration, all springs have a shaft excursion of 3.15 inches.

| Net Lift | Gross Lift |
|---|---|
| (lbs) | (lbs) |
| 6 | 40 |
| 12 | 81 |
| 16 | 94 |
| 18 | 121 |
| 23 | 157 |
| 25 | 173 |
| 32 | 220 |
| 42 | 292 |
| 50 | 346 |
| 75 | 519 |
| 100 | 690 |

Springs or other resilient power units of different powers typically have different outer diameters or other dimensions. To easily switch resilient power units, a standard connection or other accommodation is present in the lifting cassette, and an adaptor, such as a standard diameter sleeve is provided to render all resilient power units of a form compatible with resilient lifting cassette 14.

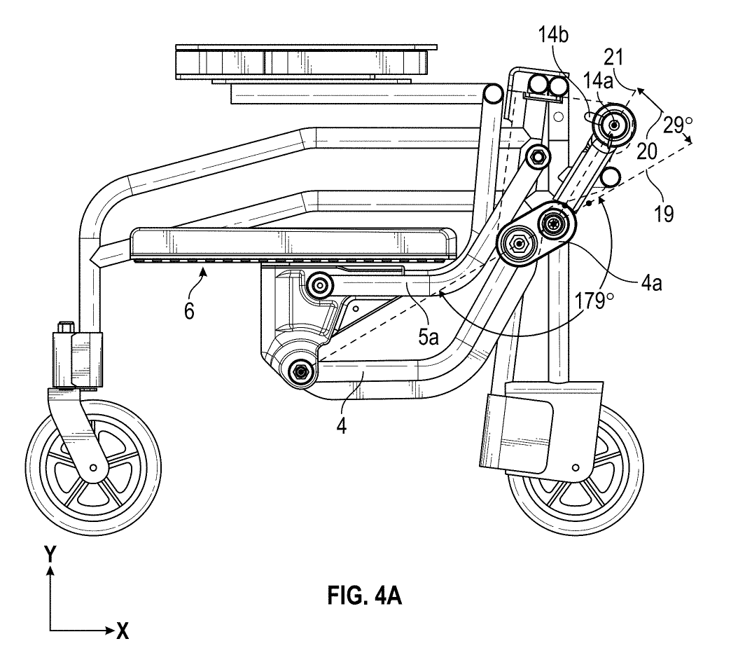

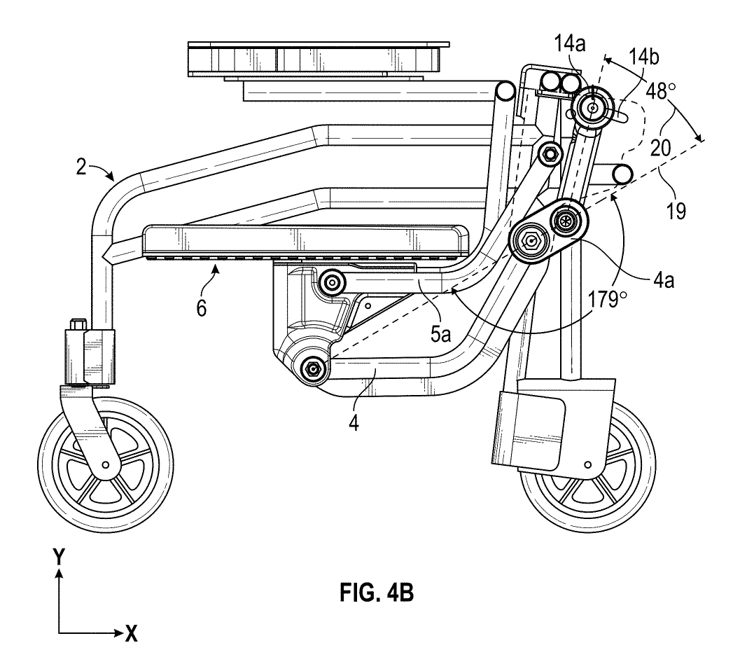

FIGS. 4a,b depict side elevations illustrating two alternate positions of cassette axle 14a along slot 14b that yield differences in payload lifting performance. The term “iso-elasticity” refers to the exemplary consistency of lifting force, from lowest to highest excursion, obtained by parallelogram arms designed to float ‘Steadicam®’ camera stabilizer payloads.’ Iso-elasticity was considered to be desirable for lifting human beings so they don't need muscle power to rise from a seated to a standing position, but unlike camera payloads, sitting humans, rising to become saddle-borne humans, weigh varying amounts throughout this transition. In practice, though most of a person's weight bears initially on the seat, the remainder (approximately half the weight of legs and feet) actually bears on the floor—and this proportion varies as someone prepares to stand up. As he or she leans forward to rise, significantly more leg weight is transferred from seat to floor. The result is that to actually ‘equipoise’ or effectively ‘zero-g’ a person throughout this transition, the amount of lift provided must likewise vary, and it is found that a consistent, ‘iso-elastic’ lift may rise too rapidly at first and then too slowly as the saddle-born occupant nears a standing posture.

FIG. 4a illustrates the optimal angle between lifting extension centerline 19 and the force applied along cassette centerline 21. The angle is achieved in this illustrative embodiment of the invention when cassette axle 14a is slid the “rear” of adjustable cassette positioning slot 14b. The resultant 29° lifting angle, in this embodiment yields a ‘super-iso-elastic’ lifting force curve that would cause an inert payload to drop excessively at the bottom of travel and rise too energetically at maximum height, but that is preferable for lifting up humans whose legs remain in contact with the floor. An illustrative angle range is from about 27° to about 31°. The resulting ‘super-iso-elasticity’ yields appropriate lifting force for two reasons: First it is powering a limited arcuate excursion at a high ‘see-saw’ ratio of force to payload weight. And second, the momentary extending force of the selected gas springs along cassette centerline 21 is applied in a direction optimally to lifting extension centerline angle 19 throughout its travel. The initial 29° force angle is inefficient for lifting and lets the occupant remain seated until he or she leans forward, thus transferring sufficient leg/foot weight to the ground to launch the parallelogram upward. The angle of the force applied to the short lever arm, designated as lifting extension frame 4a, reaches 119° just as saddle 6 reaches its maximum upward position. At this extension, gas springs 15a,b,c exert only about 0.6 of their original force, but at a relatively efficient angle to extension centerline 19, which would cause an inert payload to bump hard against the upper stops. However once the occupant's legs approach vertical and a larger percentage of his or her weight rests on the saddle, the lifting performance can more effectively equipoise the human payload.

FIG. 4b, by contrast, illustrates the optimal ‘iso-elastic’ lifting angle of 48° which, in this illustrative embodiment of the invention, would evenly lift an inert non-human payload. However, the dynamically varying human payload, as described above, would find difficulty getting himself or herself down to seat height. Particularly since a portion of descending inertia is in practice diverted to activate seat deployment (as shown in FIGS. 11a,b). And our human payload would also have difficulty reaching maximum height, since the diminishing proportion of leg weight reaching the ground would effectively make him or her heavier. Non-obviously therefore, though iso-elastic lift is achievable, it is not optimal for the very particular requirements of human equipoising according to the invention.

An illustrative lifting angle range for a more iso-elastic excursion is about 46° to about 50°. Generally, as lifting angles increase above 48°, the payload will require externally added upward or downward force to reach respectively, the top or the bottom of travel, whereas a lifting angle less than 48° may cause the payload to require added upward force to rise from the lowest position, and downward force to descend from maximum height.

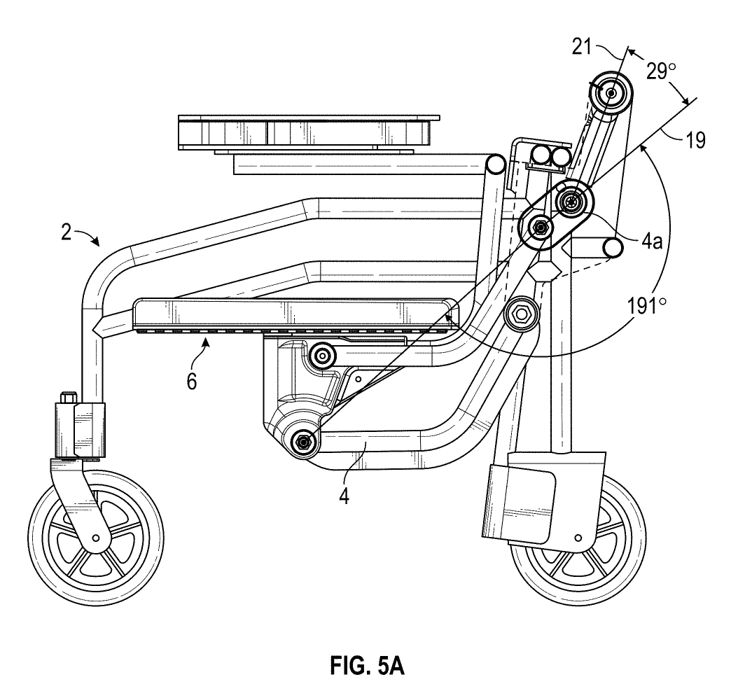

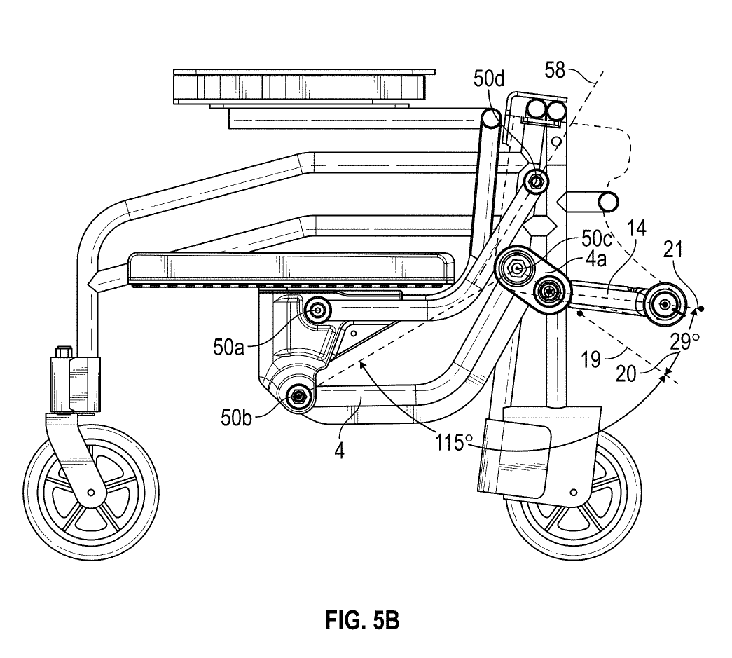

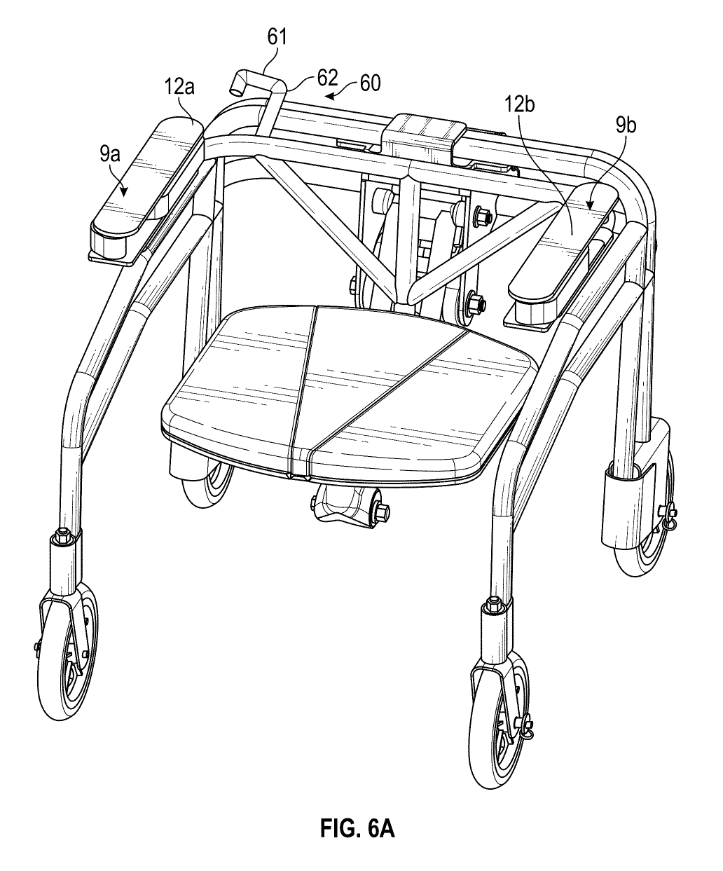

FIGS. 5a,b depict side elevations illustrating that various other selected mounting angles for lifting extension frame 4a can yield similar or identical lifting performance if the angle between resilient cassette centerline 21 and lifting-frame centerline 19 is, in each case, arranged to be 29° when seat 6 is at its lowest excursion. FIG. 5a illustrates a structural variation according to an illustrative embodiment of the invention, in which lifting extension frame 4a is attached to upper parallelogram struts 5a,b instead of to lower parallelogram lifting strut 4 as in previous figures. Note that lifting performance can be similar or identical, and thus similarly suitable for human occupants, because the angle between lifting frame centerline 19 and cassette centerline 21 has been constructed to again be 29° or there about. This arrangement can be advantageous for several reasons, including that it keeps the lifting components higher up behind the backrest, and thus, more out of the way of rearward foot and leg excursions when striding and coasting.

FIG. 5b depicts another illustrative variation in the angular location of the lifting apparatus. In this view, the lifting extension centerline 19 is at nearly right angles to the longitudinal centerline 58 of the portion of lifting strut 4 to which lifting strut 4 attaches, and resilient lifting cassette 14 is sticking straight out to the rear. Note, however, that cassette centerline angle 21 is again at a 29° angle to lifting frame centerline 19, and so this version, though merely illustrative and not particularly functional, would deliver similarly or identically appropriate lifting performance for its human payload.

As shown in FIGS. 5a,b, extension frame 4a can be rotated to any desirable angle about the pivot center at its attachment to lifting strut 4, which is illustrated at an angle of 191 degrees for the FIG. 5a configuration, and 115 degrees for the FIG. 5b configuration. Rotation of extension frame 4a can position lifting cassette 14 as desired either inside or outside of the parallelogram defined by pivots 50a,b,c,d.

The lifting unit that includes lifting cassette 14, extension frame 4a and the associated parallelogram structure, can be used in other applications in which parallelogram lifting structures can be employed, i.e. not merely in the elevating lifting chair described herein. In other words, the lifting units described herein are in essence stand-alone mechanisms that can be incorporated into other devices that require the lifting function the apparatus provides. The sides of the parallelograms of these lifting units can be bent, such as lifting strut 4 and parallelogram struts 11a,b, or may be straight as in traditional parallelogram links. Bends in the parallelogram sides can be designed to allow the optimal excursion necessary for a particular application. The lifting units may be mounted on a stand, a fixed or movable structure or even to a vest that a user would wear.

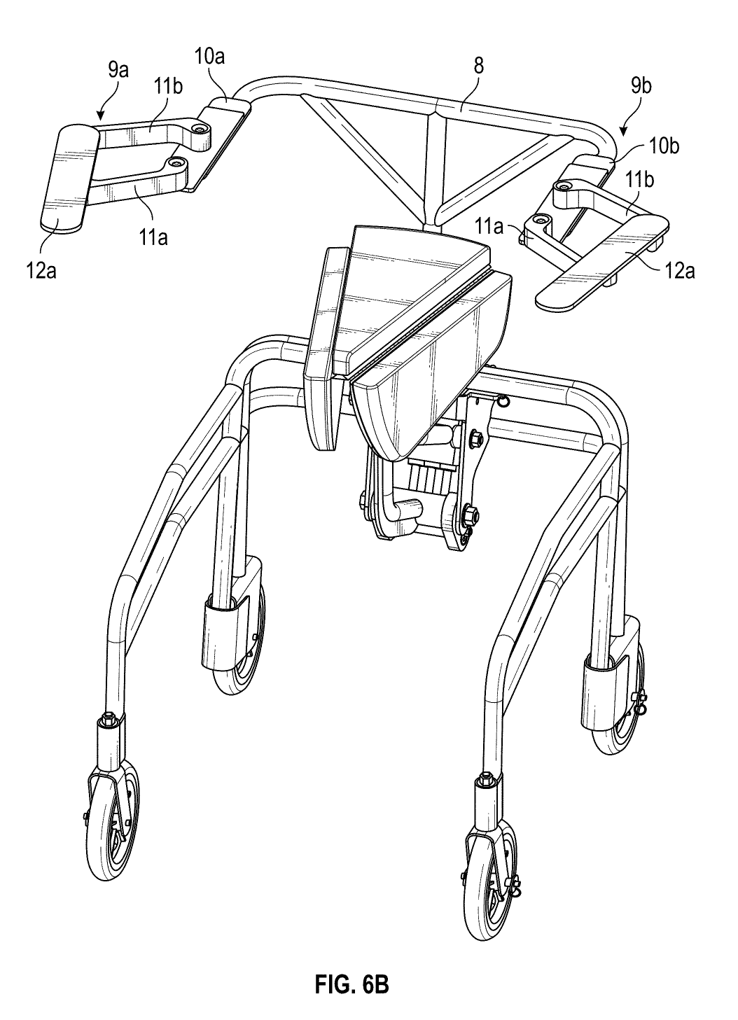

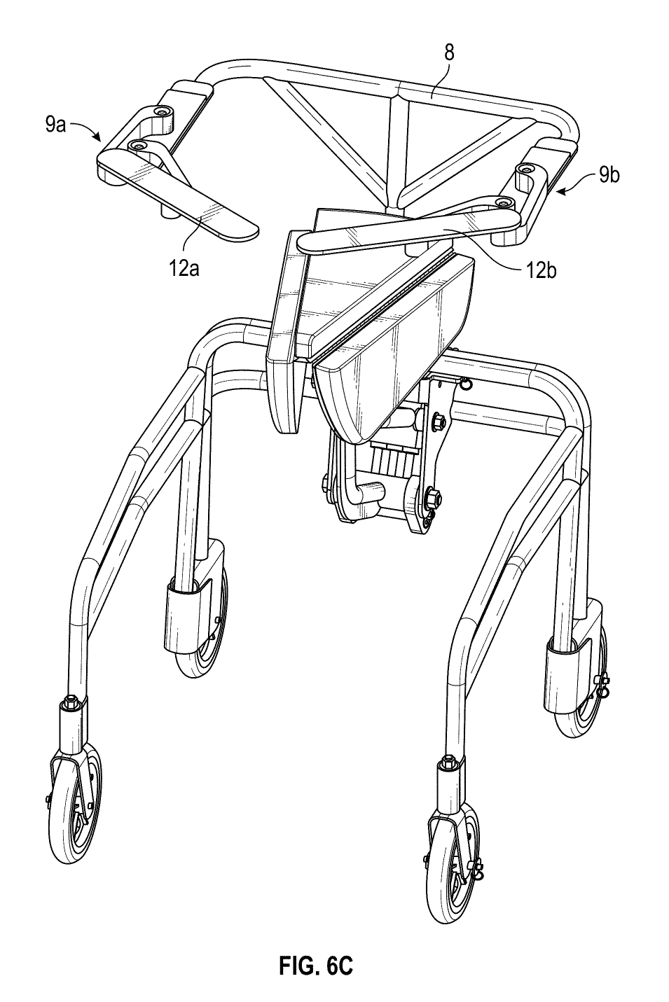

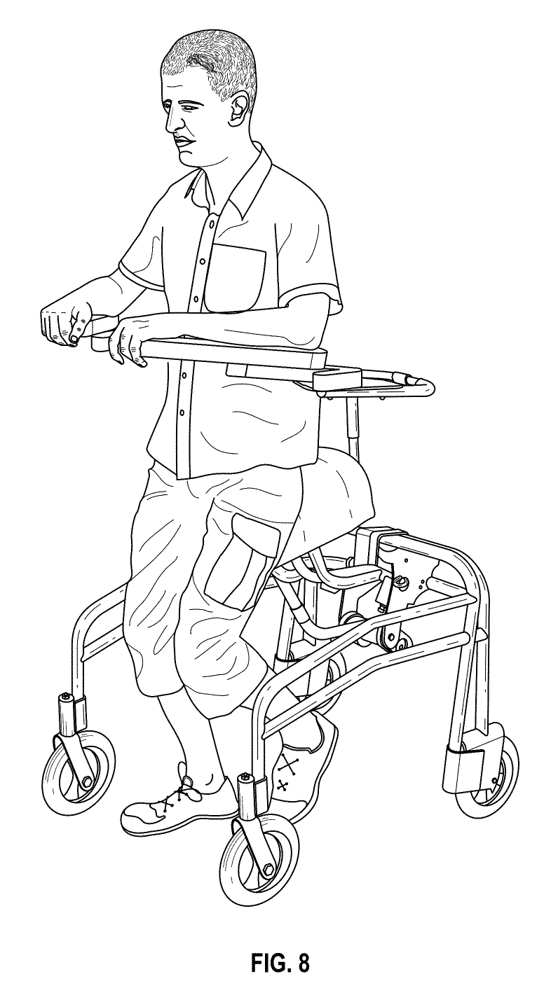

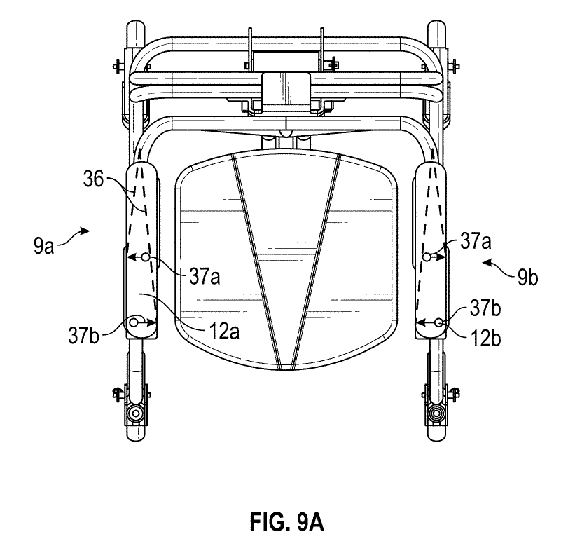

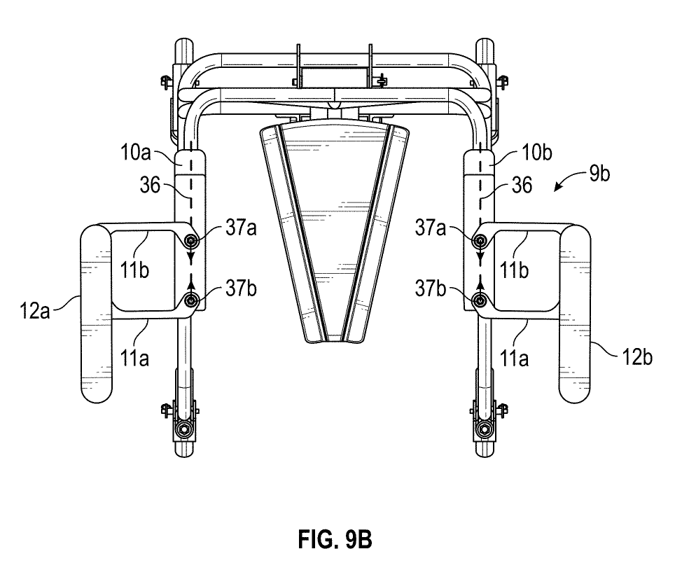

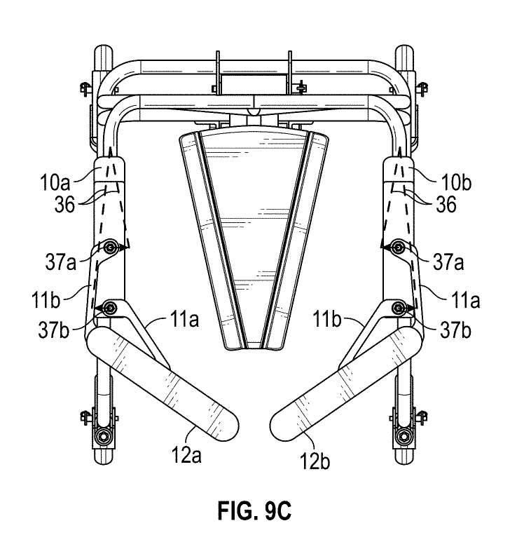

FIGS. 6a,b,c depict deployment positions for left/right armrest assemblies 9a,b that can be adapted to appropriately control the locking and unlocking of the seat height and rear wheels 17ab, as the user transitions from seat mode, upward to saddle mode and ambulation. FIG. 6a depicts the chair mode with armrests 9a,b fully retracted to serve as conventional armrests. FIG. 6b shows armrests 9a,b partially deployed. Fore/aft parallelogram deployment struts 11a,b are of uneven length and thus will begin to alter the angle of cover plates 12a,b with respect to armrest support plates 18a,b as they are swung out to the side. This armrest position is appropriate for ‘boarding’ the elevating walker chair. FIG. 6c illustrates the ultimate forward deployment of armrests 9a,b, in which the uneven parallelogram linkages swing cover plates 12ab back inward to form appropriate restraining and armrest surfaces appropriate for ambulation. As can be seen in FIGS. 9a,b,c, these three armrest positions will be employed to actuate the separate locking/unlocking of seat height and the rear wheel brakes in an illustrative embodiment of the invention.

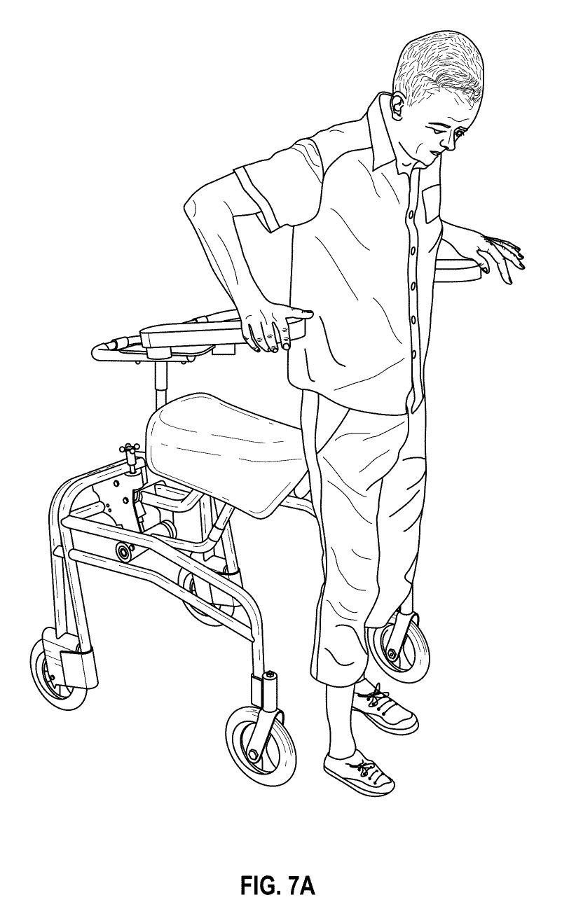

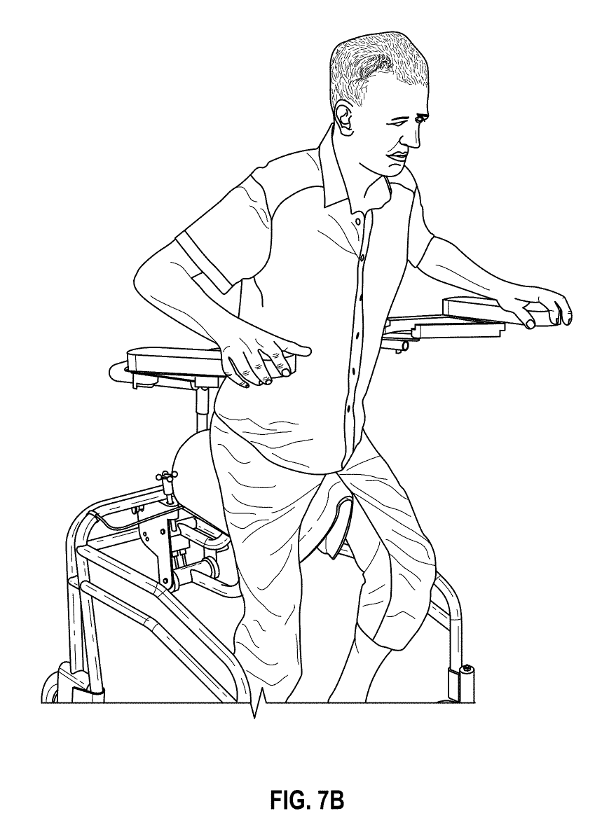

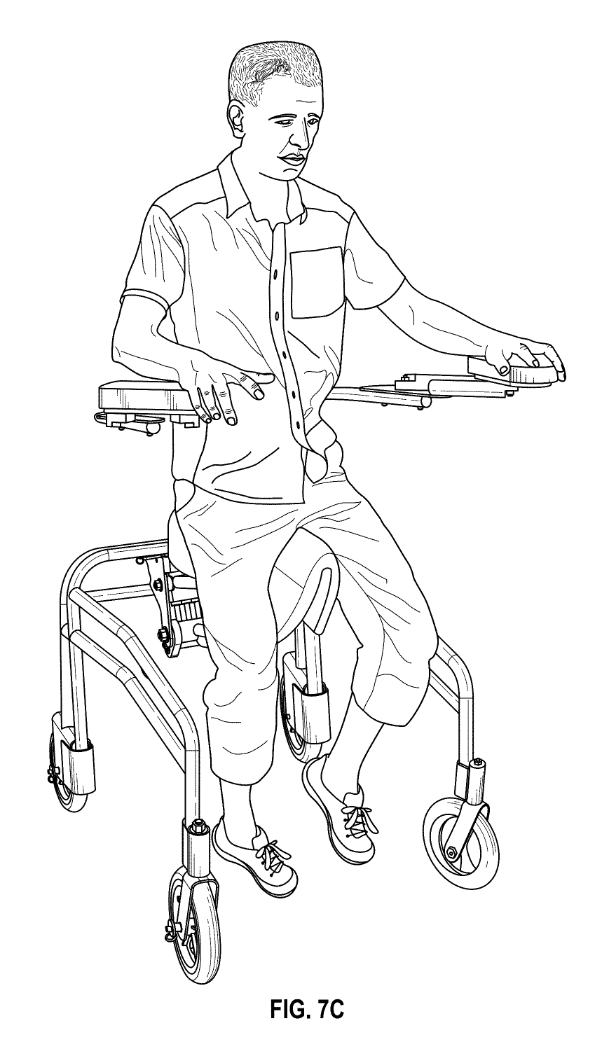

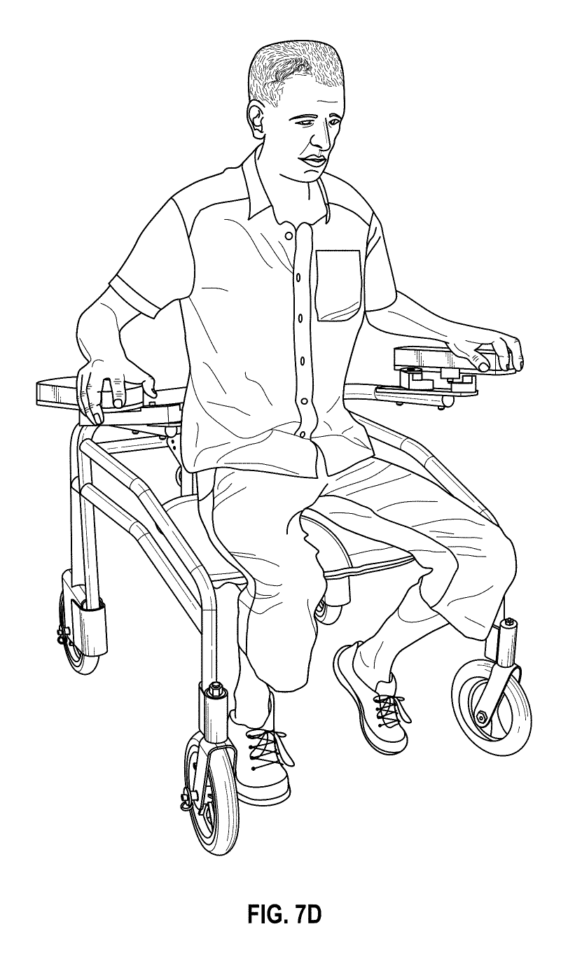

FIGS. 7a,b,c,d depicts progressive engagement by a user with the novel actuating armrest control functions of an elevating walking chair, as he boards and effects a downward transition to seated height. In FIG. 7a, the user grasps the armrests in extended position (which preferably has locked the rear wheel brakes) and approaches the saddle. In FIG. 7b he transfers his weight to the saddle and preferably fastens his seatbelt (not shown). The extended armrest position also preferably unlocks seat height. In FIG. 7c the user can be seen leaning slightly back to cause the seat to descend, while supporting all but a few pounds of his weight. In FIG. 7d the user has descended to chair height, the seat wings have automatically deployed outward and the user pulls the armrests back toward their conventional sitting position, preferably actuating the seat height lock and freeing the brakes, (by means illustrated in FIGS. 9a,b,c).

FIG. 8 depicts armrests 9a,b swung forward to a position appropriate for forward ambulation, enclosing the user, providing armrest surfaces that will facilitate ambulation, and if available in the embodiment, actuating the seat height lock, releasing the rear brakes. The user is shown in an appropriate posture for conventional walking. According to the user's level of fitness and ability, he or she may elect to lean further forward, transfer a bit more body weight to the armrests and stride with somewhat larger steps, coasting in between, and with feet and legs extending ground contact further to the rear.

An illustrative range of height variations, for example between the seated position of FIG. 7d and the striding position of FIG. 8, is about 18 inches to about 34 inches.

FIG. 9 shows right-hand actuating armrest assembly 9a depicted in perspective with transparent top cover plate 12a, to illustrate armrest positions yielded by excursions of fore/aft parallelogram struts 11a,b, which are uneven in length, and their respective actuating functions.—The upper left image shows the position of the afore-mentioned components when the arm assembly is in its retracted position. The upper right image shows armrest assembly 9a easing sideways (preferably beginning to actuate right-rear wheel brake). The lower left drawing shows armrest 9a fully extended sideways (preferably unlocking the lifting function and implementing full braking). The lower right image shows armrest 9a in its forward-most position so top cover plate extends at least partially in front of a user, thereby enclosing, stabilizing and supporting ambulating activity, and preferably locking lift and actuating the release of the right-hand wheel brake. These functions will be further illustrated in FIGS. 9a,b,c.

FIGS. 9a,b,c depict armrest 9a showing an illustrative mechanism for actuating braking and lift-locking functions throughout sequential armrest deployment positions shown. Crankshaft axles 37a,b are fixed to fore/aft armrest deployment struts 11a,b so they rotate in unison. The arrows shown extending from crankshaft axles 37a,b in FIGS. 9a,b,c indicate the direction of attached arms associated with the crankshaft axles. The crankshaft arms are adapted to pull actuating wires 36, indicated by dotted lines on both armrests. The dotted lines show the path of the central wire-ends, which can be for example, from four conventionally-terminated bicycle-type brake cables (not shown). Actuated by crankshaft axle 37a, one end of wires 36 on each armrest are preferably adapted to conventionally actuate and release its respective-side rear wheel brake. The other end of wires 36 on each side, are driven by 180 degree crankshaft axles 37b in opposing directions, which can also be employed via bike cables (not shown), to activate one of two redundant seat-height locks (not shown). The seat height locks may comprise conventional disc brakes or hydraulic locking cylinder assemblies, among other conventional braking and restraining options, preferably acting to restrain both upward and downward excursions of the lifting parallelogram of the elevating walker chair.

FIG. 9a shows armrest assemblies 9a,b in their rearward seated position. Crankshaft arms associated with crankshaft axles 37a on both armrests are directed outward (indicated by arrows), with their dotted line brake-cables 36 adjusted to cause respective left/right wheel brakes to be released. Forward crankshafts arms associated with crankshaft axles 37b on each side are inwardly directed, and their brake-type cables adjusted to cause the seat height to be locked. FIG. 9b shows armrest cover plates 12a,b swung outward and crankshaft arms (represented by arrows) fixedly associated with crankshaft axles 37a,b on both armrests respectively rotated 90° as shown. Both left and right crankshaft arms have swung forward and therefore caused ends of brake wires 36 to be extended and respective left/right wheel brakes firmly engaged. Note also that respective left/right wheel braking can thus be independently controlled by its same-side armrest position. This permits independent use of momentary slight wheel braking to retard progress of that respective left or right wheel and assist steering during ambulation. Also on left and right armrests 9a,b, crankshaft axles 37b are shown now swung to the rear, releasing their respective, redundantly dual seat-height brakes (not shown). Note that seat-height unlocking can also be independently actuated for a different reason—so that either armrest, in either seated or ambulating positions (FIGS. 9a and 9c, respectively) can effectively stop the seat from rising or falling; and both armrests must be positioned in the extended-to-the-side position shown here to release seat height lock, so that when boarding the saddle, or rising from a seated position, or merely selecting a new intermediate seat position such as ‘bar-stool’ height, seat/saddle 6 is free to raise and lower the equipoised occupant with minimal effort. FIG. 9c shows the positions of actuating crankshaft arms associated with crankshaft axles 37ab when both armrests are swung forward into the ambulating position. Note that crankshaft arms associated with crankshaft axles 37a are now inward, releasing their respective wheel-brake cables. Crankshaft arms associate with crankshaft axles 37b are respectively outward, engaging their individual seat-height locks so that ambulation is accomplished without having the saddle sink down if both feet are momentarily off the floor during, for example, coasting, or if relaxing in a high stationary position, such as at bar-stool height, with both feet on optional footrests (not shown). Note that the uneven-parallelogram deployment of the armrests is initiated by appropriately arcuate arm motions that mimic the arcuate excursion of parallelogram struts 11ab.

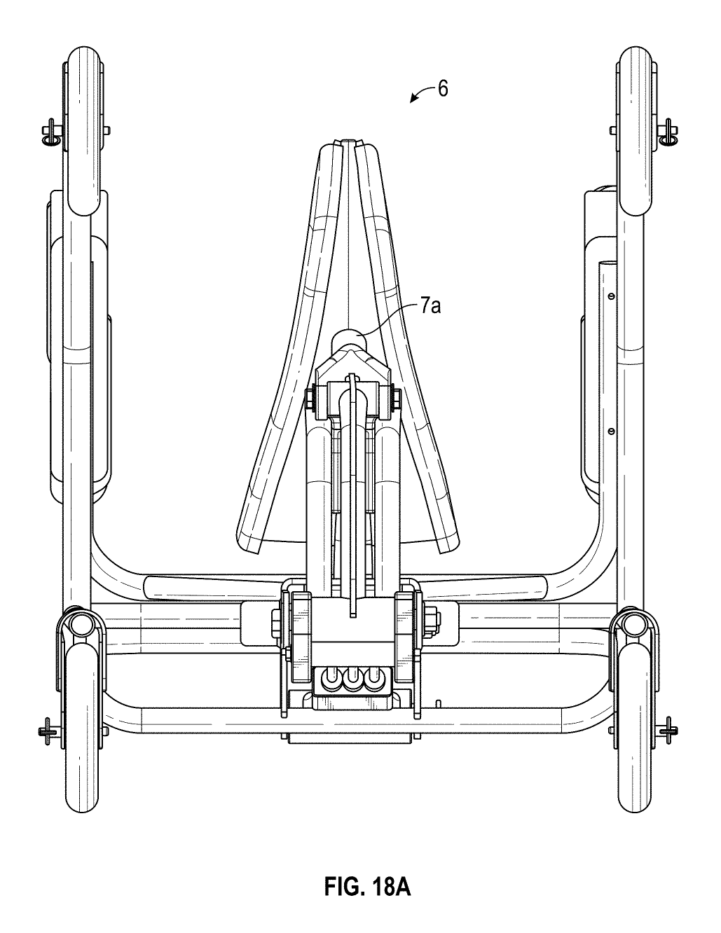

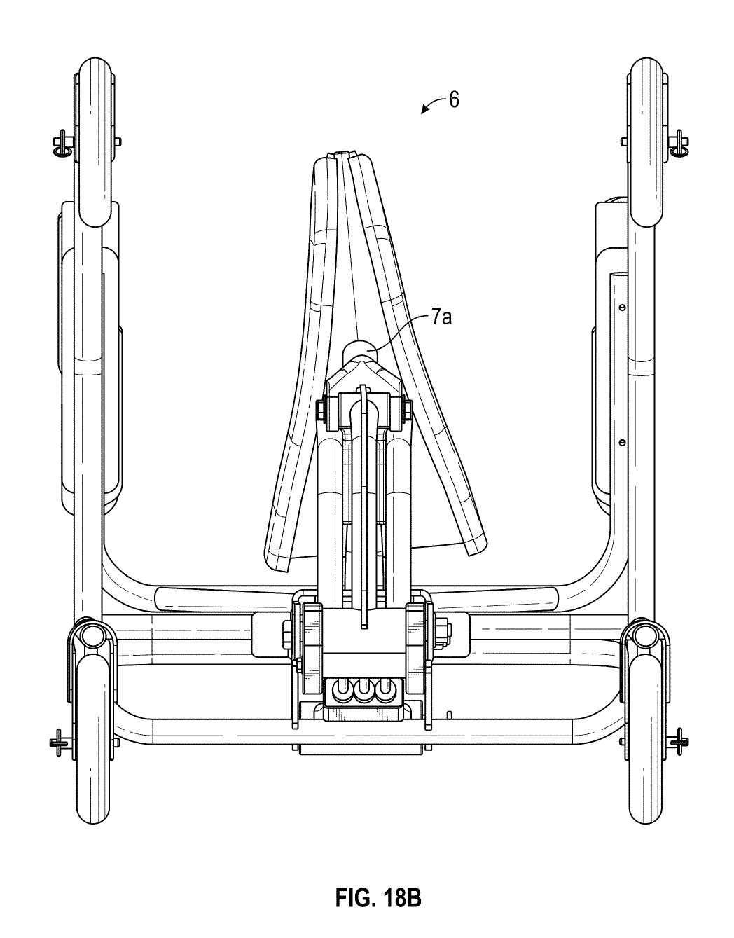

FIG. 10 depicts folding seat/saddle 6 assembly with wing 6a and seat mounting block 7 rendered transparent to show how seat mounting post 7a, rotating within seat mounting block 7 can facilitate limited dynamic side-to-side swiveling of seat/saddle 6 in order to clear a path for the occupant's rearwardly striding thighs. The novel seat-swiveling structure effectively narrows the rear width of seat 6 during vigorous ambulation, since the alternate thigh is unobstructedly heading forward as the other is swinging straight rearward in the clear path created by swinging the triangular aft end of seat 6 out of the way. FIGS. 18a and 18b show successive underside views of folded saddle/seat 6 as it swivels around the axis of seat post 7 to create an alternately unobstructed rearward path to either side. Seat 6 of the present invention is preferably adapted to swivel up to at least 15° to either side during ambulation so the wider, rear portion of the saddle moves away from the leg path and the side edge of the saddle that the impelling leg is contacting becomes parallel to the fore-aft axis of the elevating walker chair. Bumpers (not shown) or stops or merely the sides of the folded down seat wings 6a,b can limit the degree of seat rotation.

FIGS. 11a,b depict saddle/seat 6 in unfolded and folded positions, respectively, and show how seat wing 6b is swung upward by telescoping wing deployment strut 38 into seat mode as the saddle descends. Two such identical struts can be employed to simultaneously raise both seat wings 6a,b, but only the right-hand strut 38 is shown here for clarity. FIG. 11a shows an attachment mechanism that includes ball joint 39 of the upper (inner) telescoped segment of strut 38 to the underside of seat side wing 6b. FIG. 11b shows how the lower, outer section of strut 38 attaches by means of ball joint 39 and a short stand-off tube to a lower portion of parallelogram lifting strut 4, so that it has a clear path upward to wing 6b during the phases of seat deployment. Note that telescoping tube 38 is fully extended when saddle 6 is raised up with wing 6b folded down. Strut 38 only begins to raise wing 6b when its telescopic travel is fully retracted, as seat 6 approaches the bottom of its deployment into seat mode, as illustrated by comparison in FIGS. 11a and 11b.

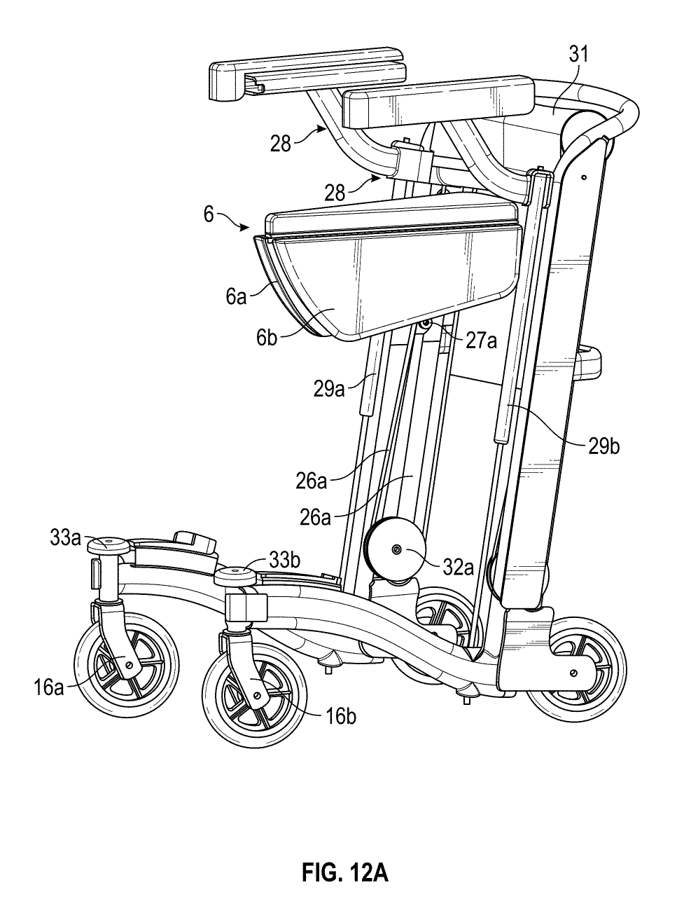

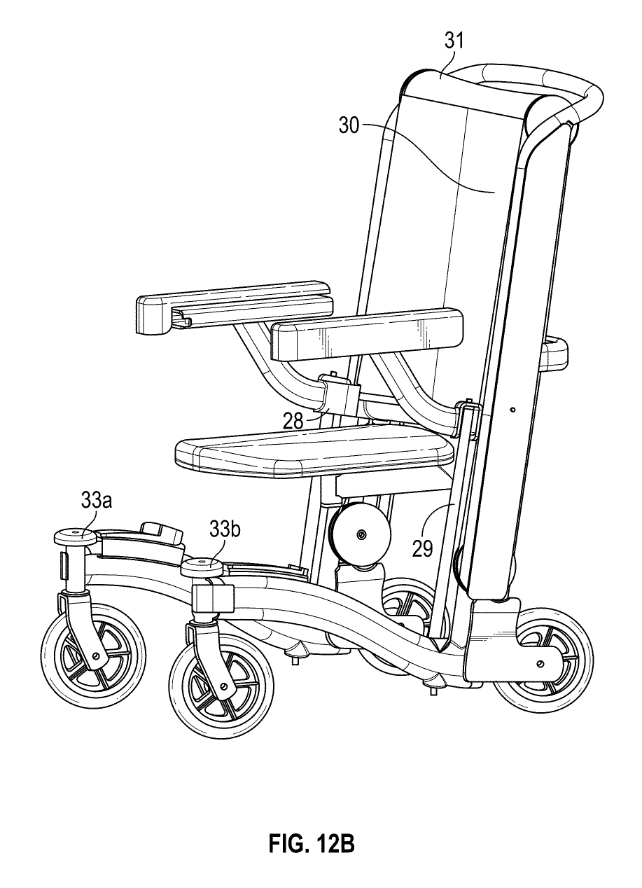

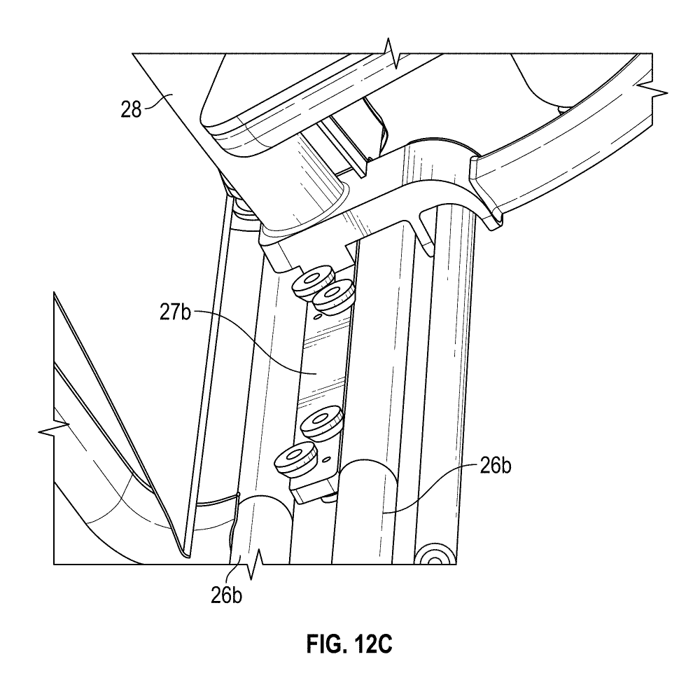

FIGS. 12a,b depict an alternate embodiment of the elevating walker chair that lifts and lowers seat carriage assembly 28 between walking and seat heights by means of left/right resilient component 29a,b and linear bearing assemblies 27a,b. FIG. 12a shows seat 6 up in saddle mode, with resilient component 29b (gas springs, for example) fully extended to cause seat carriage assembly 28 to rise up by means of left/right linear bearing assemblies 27a,b, and cause roller backrest fabric or covering 30 to retract up and over backrest roller assembly 31, tensioned by left/right backrest tensioning pulley assemblies 32a,b. The force of resilient components 29a,b, such as springs and gas springs, declines linearly as they extend and retract. As used here, to exert force straight along left/right linear bearing track pairs 26a,b, they are not ‘iso-elastic’ and will lift most strongly when fully compressed (or extended in the case of tensile resilient components). Consequently, the linearly powered embodiment of FIGS. 12a,b,c is suitable for user's who retain some leg strength and can supply the missing lifting power as seat 6 approaches the top of travel. FIG. 12b shows gas springs 29a,b fully compressed as seat carriage 28 reaches the bottom of linear bearing travel and roller backrest fabric 30 is extended and ready for use. Left/right foot-operated caster steering footplates 33a,b are fixedly associated with the swiveling axles of front swivel casters 16a,b and function as dynamic footrests that also help facilitate a form of sociable ‘pushing’ of the elevated chair, in which the occupant is up at eye-height or so with the attending person, who may easily push, for instance, the arm-rest (rather than necessarily rearward handles), and the footplates enable the rider to ‘steer’ by selectively rotating a caster to cause the chair to follow a desired path. An unaccompanied rider can also continue to ‘stride’ with one leg (skateboard style) and steer with the other, in order to progress in a precise direction, such as through a narrow doorway, and steering linkages between castors or elaborate steering geometry may not be required when only one castor is steered by this method.

FIG. 12c is a close perspective view of one of two linear bearing assemblies 27a,b running between left/right linear bearing track pairs 26a,b, to raise and lower seat carriage assembly 28, to which can also be attached seat 6, actuating armrest assemblies 9a,b, and roller backrest fabric 30. Linear bearing assemblies 27a,b function by means of tapered rollers mounted to be held in contact with opposing linear bearing track pairs 26a,b.

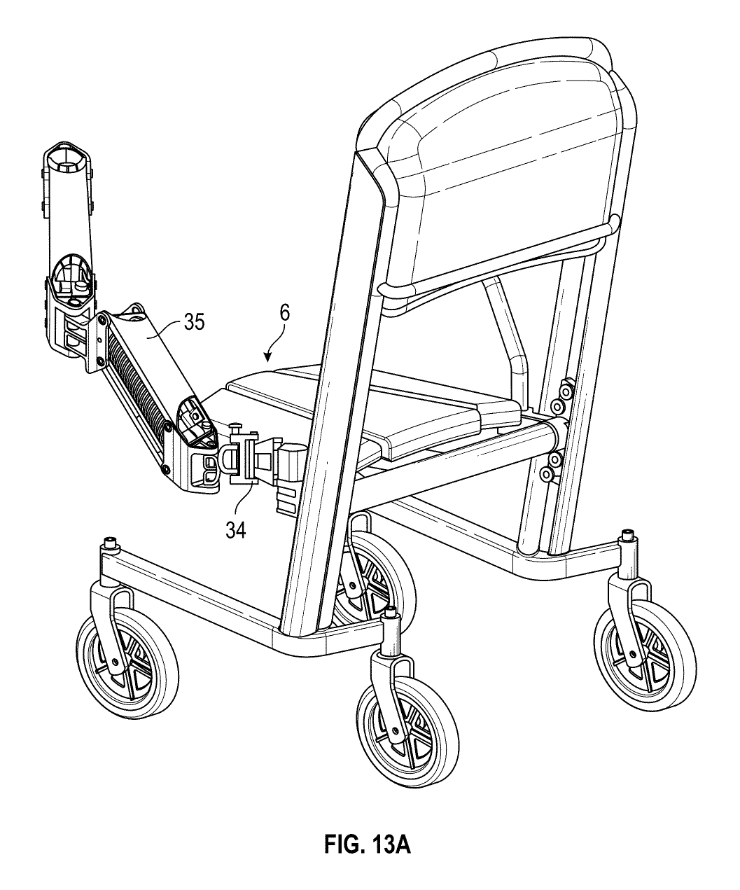

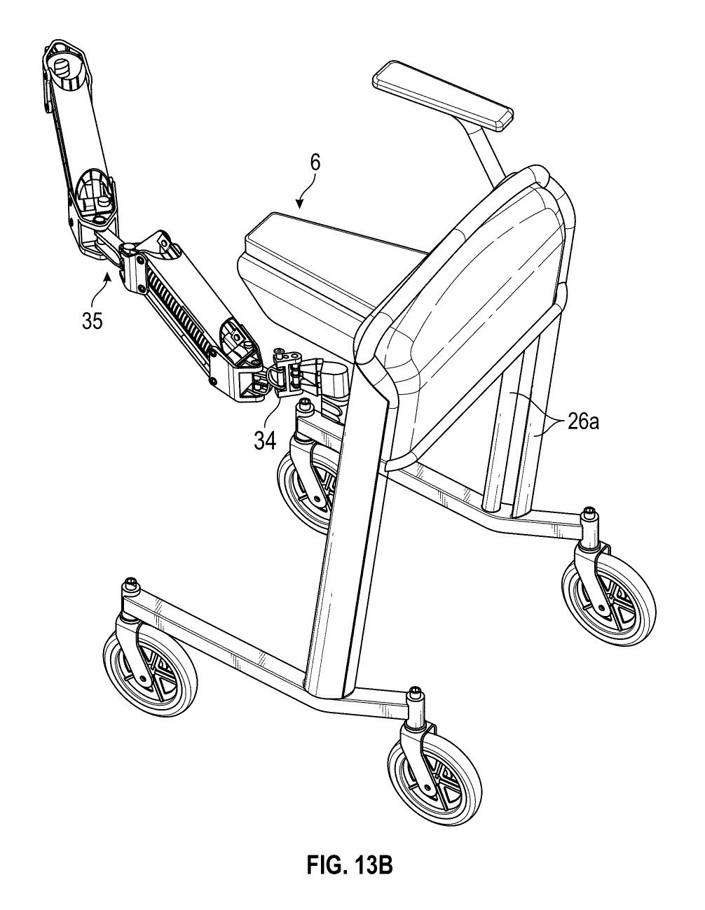

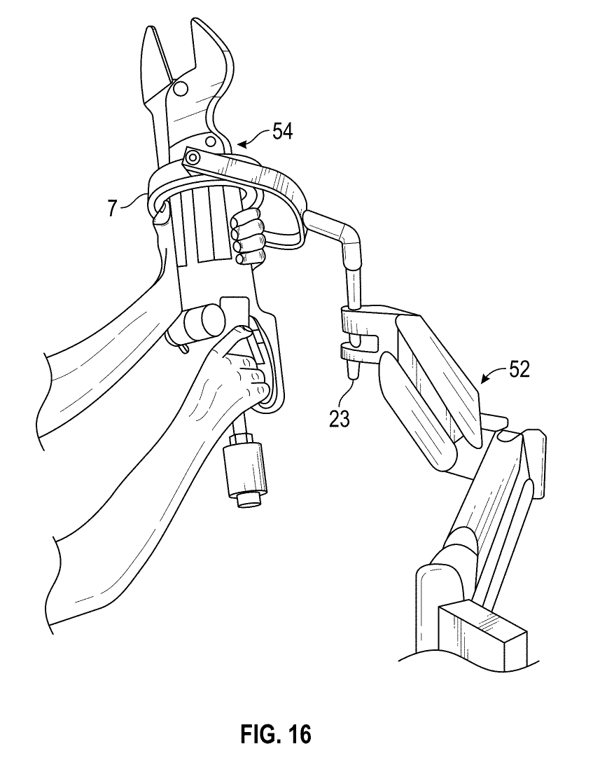

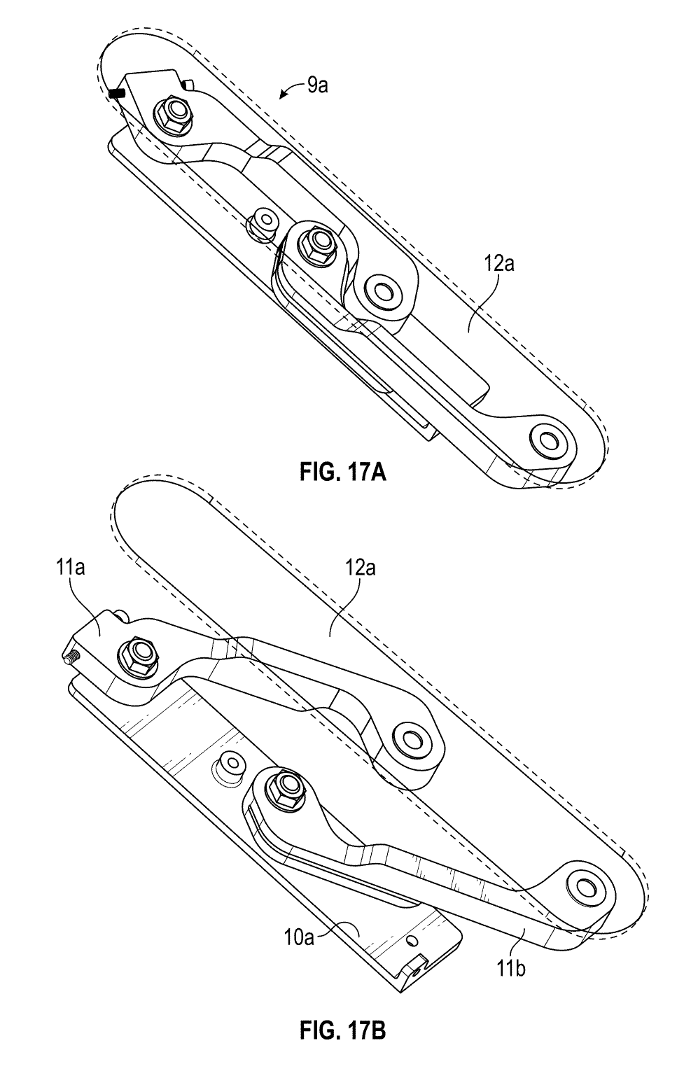

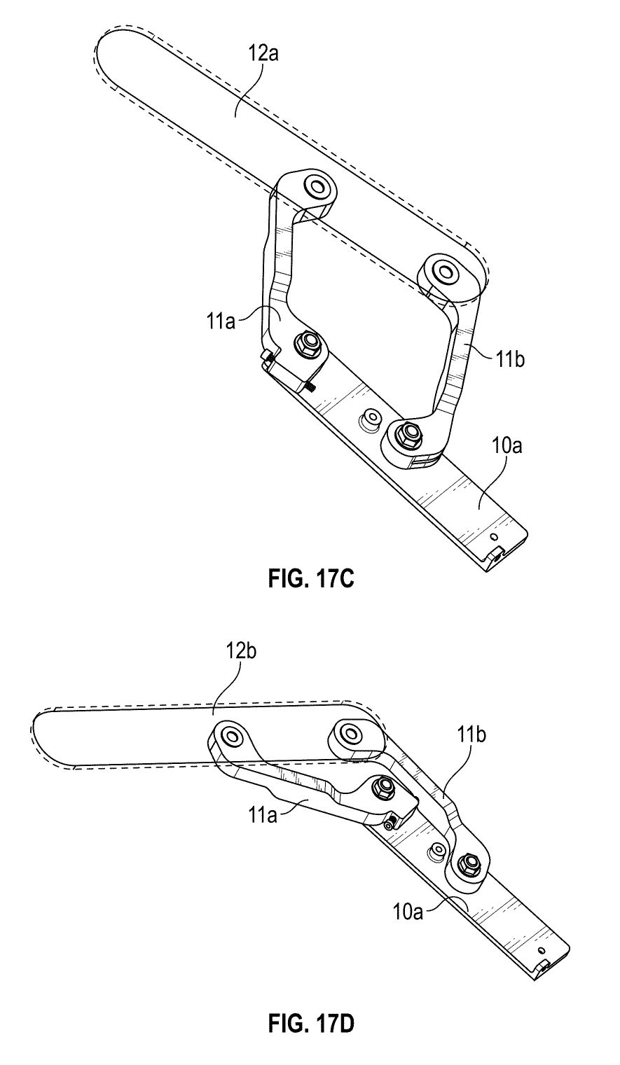

FIGS. 13a,b depict low (seat) and elevated (saddle) deployments, respectively, of an illustrative embodiment of the invention that provides support for the combined weight of a user (not shown), a resiliently powered payload support arm 35 such as the ‘Zero-G™ support arms marketed by Equipois, LLC, or other counterbalancing or equipoising arms, and a preferably gimbaled industrial payload, such as shown in FIG. 16. FIG. 16 depicts an illustrative articulated arm 52 and a gimballed tool holder 54. Other tool holders and arms may be used as appropriate for particular application, whether industrial or to provide individuals assistance with everyday tasks. FIGS. 13a,b depict lifting articulated arms with two lifting links each. Each link is of a parallelogram configuration with a resilient member to provide the lifting force. The aforementioned arms may have one or more lifting links. Attached to the distal end of the lifting arm may be a hand or arm rest that would leave a user's hands free to perform a task, while being supported by the rest that is attached to the lifting arm. This embodiment of the elevating walking chair can assist deployment of heavy tools in an industrial setting which otherwise might cause, for instance, shoulder injuries from the repetitive strain of holding them outstretched for hours of work. An industrial worker can raise himself plus the arm and tool payload to ‘saddle’ height for relatively easy ambulation between workplace opportunities and repeatedly lower to seat height and rise back up again, depending on the altitude of any particular task.

Particular embodiments or applications of the elevating walking chair may need to more perfectly equipoise both user and payload, may therefore utilize the iso-elastic parallelogram powered embodiment illustrated in FIG. 1, with which an occupant might readily perform ‘pick and place’ (otherwise called ‘material handling’) operations. Such an elevating walker chair would preferably be configured to allow heavy items to be picked up and transported with little effort and little risk of injury, by lowering a worker to chair height, engaging the arm with the payload, rising up with minimal leg effort, maneuvering the payload to its resting place, and sinking down to unload the arm (which may be conveniently restrained at any selected maximum height). This procedure displaces the weight of the transported payload from the hands to the much more powerful thighs and calves, and ‘floats’ the worker's own weight throughout the ‘pick and place’ operation.

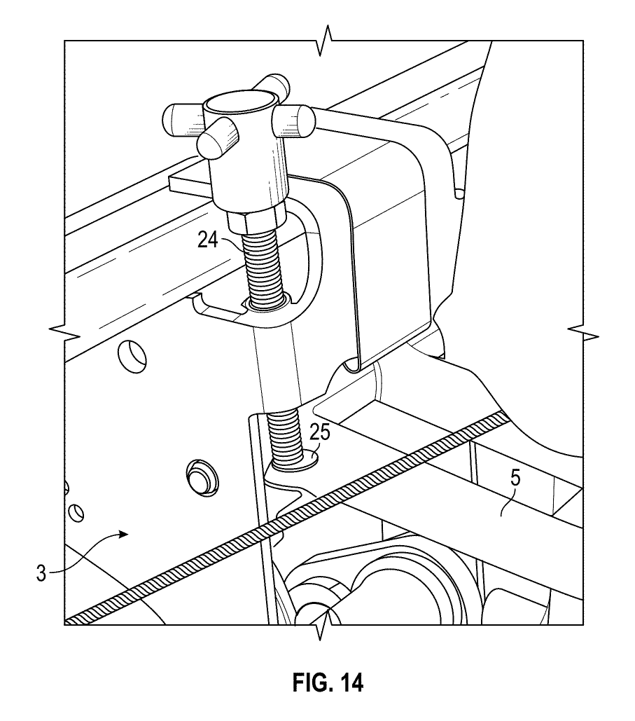

FIG. 14 depicts maximum height adjusting screw 24 and striker plate 25 functioning to restrain one of upper parallelogram struts 5a,b in order to set maximum saddle height as appropriate for the user's inseam measurement, and to ensure that height saddle/seat 6 is appropriately restrained to ease his or her ‘get aboard’ transition from an adjacent unsupported standing position—as well as to set the optimum saddle height for ambulation.

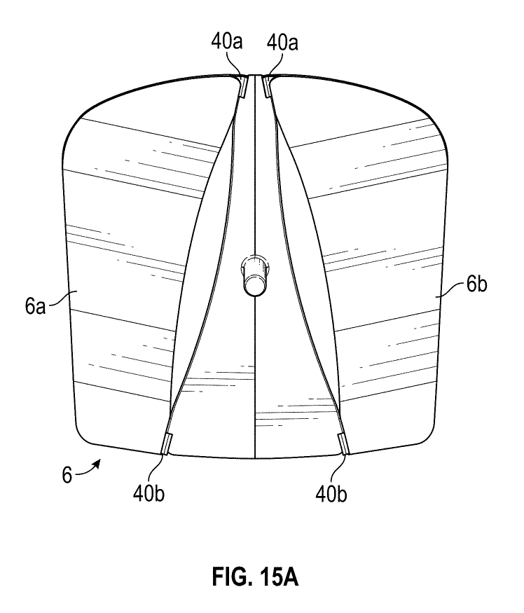

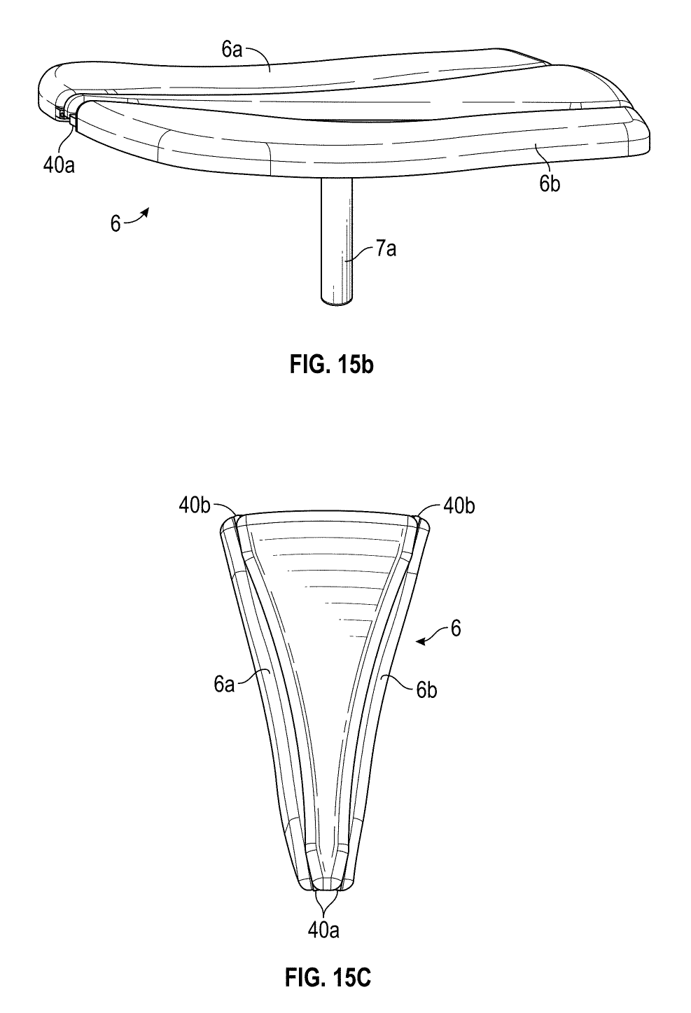

FIGS. 15a,b,c depict an illustrative embodiment of folding seat/saddle 6 that is curved to be ergonomically compatible with the human form in both the unfolded ‘seat’ mode and the folded ‘saddle’ mode, and that provides the narrowness forward appropriate for male riders and the somewhat increased width slightly farther aft that is generally more comfortable for women. FIG. 15a is an underside view that shows seat folding relief cut-outs 41a,b that permit the slightly curved plane of seat 6, including wings 6a,b and the central triangular portion to join closely together when folded, yet still preserve optimal narrowness at the forward area as a saddle. Shown are fore/aft hinge sets 40a,b, configured in a v-pattern to fold into a pointed saddle-shape approximately an inch wide in front and 6 inches wide at the rear. Fore and aft components of hinge sets 40a,b are positioned in line with each other but interrupted in between by left and right folding seat relief cut-outs 41a,b. FIG. 15b shows the extremely shallow curve imposed on the entire unfolded top surface of seat 6, as if it were cut from a cylindrical section of extremely large radius. The result of this large-radius, ‘master’ curvature and cut-outs 41a,b, in combination with hinge sets 40a,b, is an upholstered shape that, in FIG. 15c can be seen to fold into a saddle shape of exemplary narrowness. Upholstery materials, such as gel sections and elastic covering materials are preferably used so seat 6 remains narrow but is comfortably padded, when folded into a saddle, as well as when unfolded into a seat. Non-upholstered saddles are also an option.

The topology of this master curve compounds when folded and helps prevent bulging of upholstery when unfolded, as the radius of folding has not increased as much as it would around intact straight hinge lines. Excess material can ‘cut the corner’ and be drawn inward into the cut-out gaps when folded and resiliently released when unfolded. Strong flexible outer covering material will also help ensure that a rider's clothing is not pinched by the sides of cut-outs 41a,b as they close together. Note that as the radius of the master curvature decreases, and the width of folding relief cut-outs 41a,b increases, the folded saddle becomes progressively narrower.

The concept of ‘iso-elasticity’ as relates to lifting means is explained by Garrett W. Brown's various patents, including, U.S. Pat. Nos. 8,066,251; 5,360,196; 7,618,016; 5,435,515; Re. 32,213; 6,030,130; 4,394,075; and 4,208,028 (incorporated herein by reference).

Various embodiments of the invention have been described, each having a different combination of elements. The invention is not limited to the specific embodiments disclosed, and may include different combinations of the elements disclosed or omission of some elements and the equivalents of such structures.

While the invention has been described by illustrative embodiments, additional advantages and modifications will occur to those skilled in the art. Therefore, the invention in its broader aspects is not limited to specific details shown and described herein. Modifications may be made without departing from the spirit and scope of the invention. Accordingly, it is intended that the invention not be limited to the specific illustrative embodiments, but be interpreted within the full spirit and scope of the appended claims and their equivalents.

1.-20. (canceled)

21. An elevating walker chair comprising:
a frame having a plurality of wheels attached thereto creating a rollable structure;
the frame having a front and a back, the front being the side of the elevating walker chair that leads when an occupant is ambulating in a forward motion;
the frame configured so the occupant of the elevating walker chair accesses the chair from the front;
a lifting unit;
the lifting unit comprising:
a lifting chassis attached to the frame;
the chassis having a parallelogram structure with an extension frame attached to a lifting strut that form sides of the parallelogram; and
a resilient member attached to the extension frame via a receiver bar;
a saddle to support an occupant;
the lifting unit capable of elevating the saddle; and
the lifting unit capable of counterbalancing an occupant's weight at least in part thereby reducing the force needed for the occupant to move from a seated position to a more erect position.

22. The elevating lifting chair of claim 21 wherein:
the saddle is transformable from a saddle to a seat; and
the lifting unit is functionally attached to the saddle so that the saddle transforms to a seat upon lowering and the seat transforms to a saddle upon elevation.

23. The elevating walker chair of claim 21 wherein the saddle swivels.

24. The elevating walker chair of claim 23 wherein the degree of swivel rotation of the saddle about a vertical axis is about +−15 degrees.

25. The elevating walker chair of claim 22 wherein the saddle has a central portion and a right wing and a left wing, wherein each wing is attached to the seat central portion at two hinges positioned at opposing ends of the interfaces between the seat central portion and the left and right wing.

26. The elevating walker chair of claim 22 comprising a telescoping strut deployment mechanism for transforming the occupant support between a seat and a saddle.

27. The elevating walker chair of claim 21 further comprising:
a seat back frame;
a right armrest assembly attached to the seat back frame;
a left armrest assembly attached to the seat back frame;
the right and left arm rest assemblies each having:
an armrest support plate attached to the seat back frame;
a first deployment strut and a second deployment strut of a different length than the first deployment strut, each of the first and second deployment struts having a proximate end and a distal end, each pivotally attached at their proximate ends to the armrest support plate;
an armrest cover plate to which the distal ends of the first deployment strut and the second deployment strut are pivotally attached, such that the armrest support plate, the armrest cover plate and the first and second deployment struts form a four-sided structure;
wherein, the difference in length between the first deployment strut and the second deployment strut causes the cover plate to cross in front of an occupant as the first and second deployment struts are pivoted with respect to the armrest support plate.

28. The elevating walker chair of claim 22 wherein the arm rest assemblies are configured to lock and unlock the seat in a selected vertical position and locking and unlocking at least one of the plurality of wheels.

29. The elevating walker chair of claim 21 wherein at least two of the lifting unit parallelogram sides are non-linear between pivot points.

30. The elevating walker chair of claim 21 wherein the lifting unit has one or more lifting power units;
the lifting power units are configured to be exchangeable by having universal fittings; and
the lifting unit can accommodate different combinations of different power units.

31. The elevating walker chair of claim 21 wherein the lifting unit extension frame is pivotally attached to the lifting strut;
the lifting unit extension has a proximate pivot and a distal pivot;
the lifting strut has a proximate pivot and a distal pivot, wherein the lifting strut distal pivot is coincident with the lifting unit extension proximate pivot; and
the lifting unit extension frame and the lifting strut have a length ratio of about 6.9:1, wherein the length of the lifting unit extension frame is measured from its proximate pivot to its distal pivot and the length of the lifting strut is measured from its proximate pivot to its distal pivot, and both the lifting unit extension frame and the lifting strut lengths are measured in a straight line whether or not each is bent or straight.

32. The elevating walker chair of claim 21 wherein the angle between the lifting unit extension frame centerline and the force applied by the resilient member is in the range of about 27° to about 31°.

33. The elevating walker chair of claim 32 wherein the angle between the lifting unit extension frame centerline and the force applied by the resilient member is about 29°.

34. The elevating walker chair of claim 21 wherein the angle between the lifting unit extension frame centerline and the force applied by the resilient member is in the range of about 46° to about 50°.

35. The elevating walker chair of claim 34 wherein the angle between the lifting unit extension frame centerline and the force applied by the resilient member is about 48°.

36. The elevating walker chair of claim 21 wherein the range of height variations between the seat position and the saddle position is about 18 inches to about 34 inches.

37. The elevating walker chair of claim 22 comprising crankshafts disposed within at least one of the right armrests or left armrests, wherein the crankshafts are functionally attached to actuating wires, wherein the crankshafts are adapted to pull the actuating wires to engage and release wheel brakes, seat height locks, or both by movement of the right cover plate or the left cover plate.

38. A method of rehabilitation comprising:
performing physical rehabilitation using an elevating walker chair according to claim 21.

39. The elevating walker chair of claim 21 wherein the angle between the lifting force and the lifting extension centerline is adjustable.

40. The elevating walker chair of claim 21 wherein the elevating walker chair is adapted to be motorized.

41. The elevating walker chair of claim 40 comprising wireless control of the motorized functions.

42. The elevating walker chair of claim 21 wherein the seat height maximum limit is set by an adjustment screw and a limiting striker plate adapted to limit the seat height.

43. The elevating lifting chair of claim 21 comprising:
two armrests having a plurality of positions:
wherein in a first position the wheels are locked;
a second position wherein the wheels are unlocked and the seat height is locked; and
a third forward position that locks the height of the saddle and frees the wheels, but allows the user to lean forward onto the armrests;

44. The elevating walker chair of claim 21 comprising:
a right armrest and a left armrest, each having a plurality of positions;
a braking mechanism that can be activated by movement of one or both of the armrests, and which upon braking to substantially eliminate a rolling motion the seat lowers the occupant toward a seated position.

45. A lifting device comprising:
a lifting chassis attached to a frame;
the chassis having a parallelogram structure with an extension frame attached to a lifting strut that form sides of the parallelogram; and
a resilient member attached to the extension frame via a receiver bar.

46. An elevating walker chair having lifting power provided by a resilient component biasing upward a parallelogram mount, which extends between a rear structural arch and the bottom post of the seat assembly;
in the lower ‘seat’ position, the parallelogram is biased downward by the rider's weight;
in the upper position the rider is lifted up to the ‘saddle’ position; and
wherein optionally the lifting power can be adjusted by displacing the termination point of the resilient component.

47. An elevating walker chair comprising:
a frame on wheels;
the frame having a front and a back, the front being the side of the elevating walker chair that leads when an occupant is ambulating in a forward motion;
the frame configured so the occupant of the elevating walker chair accesses the chair from the front;
a bicycle-like saddle convertible into a chair seat, wherein the seat folds into a saddle as the seat rises;
a right armrest;
a left armrest;
the armrests having a plurality of positions adapted to control braking and seat height locking functions concurrently;
the apparatus configured so an occupant can use his own legs for locomotion and in a standing or near standing position can utilize a normal or near normal gait;
the saddle supported by a lifting unit configured to adjustable the saddle upward or downward; and
wherein the seat swivels to facilitate the occupant using his own legs for locomotion.

48. An elevating walker chair comprising:
a frame on wheels;
a bicycle-like saddle convertible into a chair seat, wherein the seat folds into a saddle as the seat rises;
a right armrest;
a left armrest;
two armrests having a plurality of positions:
wherein in a first position the wheels are locked;
a second position wherein the wheels are unlocked and the seat height locked;
a third forward position that locks the height of the saddle and frees the wheels, but allows the user to lean slightly forwards onto the armrests;
a braking mechanism that can be activated by movement of the armrests, and which optionally on applying full braking power, the seat height becomes free, such that the user sinks down to a seated position;
footrests configured to influence steering;
the apparatus configured so a user can use his own legs for locomotion and in a standing or near standing position can utilize a normal or near normal gait;
the saddle being spring loaded to carry a proportion of the user's weight, which may be adjusted up and down;
a power-elevating mechanism to elevate the seat height, for example by gas springs and linear bearings;
wherein the seat/saddle has fore-aft hinges in a v-pattern that provide for a “pointed” saddle-shape when folded, approximately an inch wide in front and 6 inches wide at the rear;
a seat height locking and wheels braking mechanism comprising:
cams on the two fixed points around which the armrest pivots with cables attached;
one cam can pull a cable attached by an eye to the ‘bow string’, which engages the brake, and pushing the armrest behind normal position brings this cam ‘over centers’ releasing the brake;
a second cam is orientated at 180 degrees to the first, so when the armrest is pushed forward, it pulls the seat-back rope into a cleat, and can also work ‘over centers’ so the seat height is locked also when the armrest is pulled aft; and
each wheel brake is controlled independently.
